(19) United States
(12) Patent Application Publication
(10) Pub. No.: US 2026/0072369 A1
(43) Pub. Date: Mar. 12, 2026

(54) MAGNETIC ONE-COMPONENT TONER AND IMAGE FORMING APPARATUS USING IT

(71) Applicant: KYOCERA Document Solutions Inc., Osaka (JP)

(72) Inventor: Toshiki TAKEMORI, Osaka (JP)

(73) Assignee: KYOCERA Document Solutions Inc., Osaka (JP)

(21) Appl. No.: 19/320,128

(22) Filed: Sep. 5, 2025

(30) Foreign Application Priority Data
Sep. 11, 2024 (JP) 2024-157161

(51) Int. Cl. G03G 9/093; G03G 9/08; G03G 9/083; G03G 9/087; G03G 9/09; G03G 15/09; G03G 21/00

(52) U.S. Cl. CPC G03G 9/09342; G03G 9/081; G03G 9/0815; G03G 9/0833; G03G 9/08755; G03G 9/0906; G03G 15/0907; G03G 15/0914; G03G 21/0011; G03G 2215/0619

(57) ABSTRACT

Magnetic one-component toner has toner particles including: a toner base particle containing at least a binder resin and a magnetic powder; and an external additive attached to the surface of the toner base particle. The toner base particle contains a nigrosine dye. The external additive contains strontium titanate particles of which the surface is hydrophobically treated. The amount of nitrogen element in toner particles is 0.5 mass % or more but 5 mass % or less. The Abs value representing the amount of nigrosine dye that dissolves when toner particles are immersed in methanol as expressed in terms of light absorbance is 0.2 or more but 2.0 or less. The volume resistivity of strontium titanate particles is 1.0 E+7 [Ω·cm] or more but 1.0 E+10 [Ω·cm] or less.

### INCORPORATION BY REFERENCE

This application is based on and claims the benefit of priority from Japanese Patent Application No. 2024-157161 filed on Sep. 11, 2024, the contents of which are hereby incorporated by reference.

### BACKGROUND

The present disclosure relates to magnetic one-component toner and to an image forming apparatus employing a magnetic one-component development method that uses magnetic one-component toner.

Generally, in an electrophotographic method, the surface of an electrostatic latent image carrying member is electrostatically charged by corona discharge or the like and then it is exposed to laser light or the like to form an electrostatic latent image. The formed electrostatic latent image is developed with toner to form a toner image. The formed toner image is transferred to a recording medium to produce a high-quality image.

As methods for developing an electrostatic latent image with toner, there are known a magnetic one-component development method using only magnetic toner and a two-component development method using two-component developer containing non-magnetic toner and magnetic carrier. Magnetic toner is less expensive than two-component developer, so the magnetic one-component development method is widely used in monochrome printers.

In the magnetic one-component development method, there is increasing demand for higher coloring ability of magnetic toner so that printing with high blackness can be achieved even with a small amount of magnetic toner. The coloring ability of magnetic toner increases as the amount of magnetic iron oxide in the toner is increased, but doing so greatly affects image quality, leading to inconveniences such as insufficient charging, poor fixing properties, and wear of components (developing rollers, cleaning blades, and the like) that make contact with the toner.

### SUMMARY

According to one aspect of the present disclosure, magnetic one-component toner has toner particles including: a toner base particle containing at least a binder resin and a magnetic powder; and an external additive attached to the surface of the toner base particle. The toner base particle contains a nigrosine dye. The external additive contains strontium titanate particles of which the surface is hydrophobically treated. The amount of nitrogen element in toner particles is 0.5 mass % or more but 5 mass % or less. The Abs value representing the amount of nigrosine dye that dissolves when toner particles are immersed in methanol as expressed in terms of absorbance is 0.2 or more but 2.0 or less. The volume resistivity of strontium titanate particles is 1.0 E+7 [Ω·cm] or more but 1.0 E+10 [Ω·cm] or less.

### BRIEF DESCRIPTION OF THE DRAWINGS

FIG. 1 is a schematic sectional view of an image forming apparatus in which magnetic one-component toner of the present disclosure is used.

### DETAILED DESCRIPTION

### [1. Overall Configuration of Image Forming Apparatus]

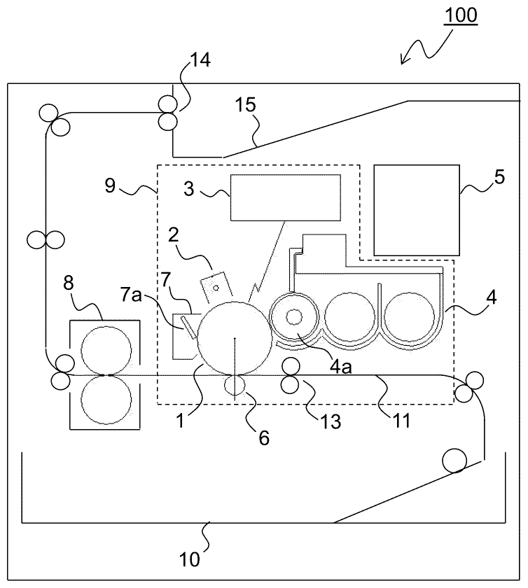

Now, an embodiment of the present disclosure will be described with reference to the accompanying drawings. FIG. 1 is a schematic sectional view of an image forming apparatus 100 in which magnetic one-component toner of the present disclosure is used. In the image forming apparatus (e.g., a monochrome printer) 100, when printing operation is performed, within the image forming apparatus 100, an electrostatic latent image based on document image data transmitted from a host device (not shown) such as a personal computer is formed in an image forming portion 9 and the toner is attached to the electrostatic latent image in a development device 4 to form a toner image. The toner is supplied from a toner container 5 to the development device 4. In the image forming apparatus 100, while a photosensitive drum 1 is rotated clockwise in FIG. 1, an image forming process for the photosensitive drum 1 is performed.

In the image forming portion 9, along the rotation direction (clockwise) of the photosensitive drum 1, there are arranged a charging device 2, an exposure unit 3, the development device 4, a transfer roller 6, a cleaning device 7, and a charge elimination device (not shown). The photosensitive drum 1 is, for example, an aluminum drum with a photosensitive layer laid on its surface (outer circumferential surface). The surface (outer circumferential surface) of the photosensitive drum 1 is uniformly charged by the charging device 2. Then, on the surface of the photosensitive drum 1 irradiated with a light beam from the exposure unit 3, which will be described later, an electrostatic latent image is formed through attenuation of electric charge. While the photosensitive layer described above is not particularly limited, it preferably is, for example, a layer of amorphous silicon (a-Si), which has excellent durability.

The charging device 2 uniformly charges the surface of the photosensitive drum 1. Usable as the charging device 2 is, for example, a corona discharge device that produces electric discharge by applying a high voltage to a thin wire or the like as an electrode. Instead of the corona discharge device, it is also possible to use a contact type charging device that applies a voltage with a charging member, typically a charging roller, in contact with the surface of the photosensitive drum 1. The exposure unit 3 irradiates the photosensitive drum 1 with a light beam (e.g., laser beam) based on image data to form the electrostatic latent image on the surface of the photosensitive drum 1.

The development device 4 attaches toner to the electrostatic latent image on the photosensitive drum 1 to form a toner image. In this embodiment, magnetic one-component toner (magnetic one-component developer) is stored in the development device 4. The development device 4 employs a magnetic one-component jumping development system and includes a mechanism that charges the toner via the developing roller 4a. The cleaning device 7 includes a cleaning blade 7a that makes line contact with the photosensitive drum 1 along its longitudinal direction (the direction perpendicular to the plane of FIG. 1), and after the toner image is moved (transferred) to a sheet, it removes, with the cleaning blade 7a, the toner remaining on the surface of the photosensitive drum 1.

Toward the photosensitive drum 1 having the toner image formed as described above, a sheet is conveyed from a sheet storage portion 10 via a sheet conveyance passage 11 and a pair of registration rollers 13 to the image forming portion 9 with predetermined timing. The transfer roller 6 makes contact with the photosensitive drum 1 to form a nip portion (transfer nip portion) and moves (transfers) to the sheet passing through the transfer nip portion the toner image formed on the surface of the photosensitive drum 1 so as not to disturb it. After that, in preparation for the subsequent formation of a new electrostatic latent image, the toner remaining on the surface of the photosensitive drum 1 is removed by the cleaning device 7 and the remaining charge is removed by the charge elimination device.

The sheet having the toner image transferred to it is separated from the photosensitive drum 1 and is conveyed to a fixing device 8, where it is heated and pressed so that the toner image is fixed to the sheet. After passing through the fixing device 8, the sheet passes through a pair of discharge rollers 14 and is discharged to a sheet discharge portion 15.

### [2. Basic Configuration of Toner]

Now, magnetic one-component toner (hereinafter, referred to simply as toner) of the present disclosure used in the image forming apparatus 100 will be described in detail. Unless otherwise defined, a result of evaluation with respect to a powdery substance (specifically, toner core particle, toner base particle, external additive, toner, and the like) is given as a number average of values obtained by measuring respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (LA-750; manufactured by HORIBA, Ltd.). Unless otherwise defined, a measured value of an acid value or a hydroxyl value is a value obtained by measuring in accordance with “JIS (Japanese Industrial Standards) K0070-1992.” Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in that polymer is derived from any of that compound and their derivatives. The term “(meth)acryl” is occasionally used to refer to “acrylic” and “methacrylic” collectively. The term “(meth)acryloyl” is occasionally used to refer to “acryloyl (CH₂═CH—CO—)” and “methacryloyl (CH₂═C(CH₃)—CO—)” collectively.

Toner according to the embodiment can be suitably used as positively chargeable toner for development of electrostatic latent images. The toner according to the embodiment is a powdery substance containing a plurality of toner particles (particles each configured as described later). The toner contains a magnetic powder and is used as one-component developer.

A toner particle in the toner according to the embodiment has a toner base particle and an external additive attached to the surface of the toner base particle. The toner base particle at least contains a binder resin, a magnetic powder, and a nigrosine dye as a colorant. As necessary, the toner base particle may contain, in the binder resin, a release agent, a charge control agent, and the like. Moreover, the toner according to the present disclosure has, as the external additive, strontium titanate particles externally added to the surface of the toner base particle.

In the toner according to the present disclosure, for the purpose of enhancing the blackness and the positive chargeability of the toner, a nigrosine dye is dispersed in the binder resin in the toner base particle. While as high an amount of nigrosine dye as possible is considered to be preferred for enhanced blackness of toner, it adversely affects the charging properties of toner, such as by worsening its dispersibility in the binder resin and causing overcharging of the toner. As a result, image defects occur such as scattering of toner in a non-image (blank background) part (i.e., fogging) and low image density due to insufficient development (attached amount of toner).

Excessive charging of the toner can be prevented by adding strontium titanate particles as the external additive. In magnetic one-component jumping development, a high charge amount of the toner base particles leads to a stable charge state of the toner. The presence of strontium titanate, which is highly dielectric, on the surface of the toner base particles acts to adjust the electric charge among the toner particles into a uniform state. Thus, by combining the toner base particles containing a nigrosine dye with, as the external additive, strontium titanate particles, it is possible to obtain extremely stable image quality.

The toner according to the present disclosure has the nigrosine dye added to the toner base particles to enhance the blackness and the positive chargeability of the toner, so there is no need to reduce the particle size of magnetic powder nor to increase the amount of magnetic powder added. It is thus possible to reduce the exposure of the magnetic powder on the surface of the toner base particles and to prevent the wear of a developing roller, a cleaning blade, and the like that make contact with the toner. Accordingly, as shown in FIG. 1, the toner can suitably used in particular in an image forming apparatus 100 employing a magnetic one-component jumping development system and a blade cleaning system.

### [3. Materials for Toner]

A description will be given below, one by one, of the binder resin, the magnetic powder, the colorant, the release agent, and the charge control agent that form the toner base particle, the external additive that is externally added to the toner base particle, and a method of producing the toner according to the present disclosure.

### (Binder Resin)

The toner base particle of the toner according to the present disclosure contains a binder resin. The binder resin that can be contained in the toner base particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties on sheets, those containing at least one of polyester resin and styrene-acrylic-based resin is preferred, and polyester resin is more preferred. The polyester resin will be described below.

Usable as polyester resin are those obtained by condensation polymerization or condensation copolymerization of a dihydric or a trihydric or higher alcohol component and a divalent or a trivalent or higher carboxylic acid component. Examples of components used to synthesize polyester resin include alcohol components and carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanethiol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebactic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of its mass average molecular weight (Mw) to its number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly have a cross-linked structure helps improve the heat-resistant preservation properties and durability of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tend to be poor. If the glass transition point is too low, the heat-resistant preservation properties of the toner tend to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200, manufactured by Seiko Instruments Inc.) as a measuring instrument. 10 mg of a measurement sample is put in an aluminum pan while an empty aluminum pan is used as a reference. From the endothermic curve plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Magnetic Powder)

The toner base particle contains a magnetic powder in the binder resin. Usable as the material of the magnetic powder is, for example, a magnetic iron oxide such as magnetite, maghemite, or ferrite, or a compound of a divalent metal with an iron oxide, a powder of an alloy of a metal such as iron, cobalt, or nickel or of an alloy of any of those metals with a metal such as aluminum, cobalt, copper, lead, magnesium, tin, zinc, antimony, beryllium, bismuth, cadmium, calcium, manganese, selenium, titanium, tungsten, vanadium, or a mixture of any of those powders.

The particle size of the magnetic powder is not particularly limited within the scope consistent with the object of the present disclosure. Specifically, the particle size of the magnetic powder is preferably 0.05 to 2.0 μm, and more preferably 0.1 μm or more but 1.0 μm or less. Using a magnetic powder with such a particle size makes it easy to uniformly disperse the magnetic powder in the binder resin.

For the purpose of improving the dispersion properties of the magnetic powder in the binder resin, it is possible to use a magnetic powder that is surface-treated with a surface treatment agent such as a titanium-based coupling agent or a silane-based coupling agent.

The amount of magnetic powder used is not particularly limited within the scope consistent with the object of the present disclosure. Specifically, the amount of magnetic powder used is, relative to 100 mass parts of the binder resin, preferably about 10 to 150 mass parts, and more preferably 30 mass parts or more but 60 mass parts or less. Using too large an amount of magnetic powder can result in difficulty forming images of the desired image density over a long period or extremely poor fixing properties of the toner on sheets; using too small an amount of magnetic powder can result in a propensity for fogging in images or difficulty forming images of the desired image density over a long period.

### (Colorant)

The toner base particle contains a nigrosine dye as a colorant in the binder resin. The nigrosine dye produces deep black or bluish black that can enhance the blackness of toner. The nigrosine dye has high positive chargeability and acts as a positively chargeable charge control agent, so it contributes to adjusting the positive chargeability of toner and to its charging stability.

The amount of nigrosine dye contained is, from the viewpoint of blackness, preferably 2 mass parts or more but 20 mass parts or less for 100 mass parts of the binder resin. The amount of nigrosine dye contained can be based on the amount of nitrogen element (mass %) observed in CHN analysis of toner particles. The toner according to the present disclosure has an amount of nitrogen element of 0.5 mass % to 5 mass % as observed in CHN analysis. The amount of nitrogen element is the amount of nitrogen element (mass %) derived from the nigrosine dye. An amount of nitrogen element less than 0.5 mass % leads to insufficient coloring ability, and an amount of nitrogen element more than 5.0 mass % leads to insufficient charging and hence a lower image density.

To adjust the positive chargeability and charging stability of the toner within the desired ranges, the nigrosine concentration on the surface of toner particles needs to be controlled. As a method for controlling the nigrosine concentration on the surface of toner particles, it is preferable to control the dispersion state of the nigrosine dye and it is preferable that the value of the amount of nigrosine dye that dissolves when toner particles are immersed in methanol as determined using an absorptiometer, that is, the light absorbance (Abs value), be 0.2 to 2.0. As a method for controlling the dispersion state of the nigrosine dye, the particle size of the nigrosine dye can be adjusted; the desired dispersion state can be obtained by melting and kneading a nigrosine dye with an adjusted particle size of 1 to 20 μm with other toner materials such as a binder resin.

The toner according to the present disclosure may contain any colorant other than a nigrosine dye within the scope consistent with the effect of the present disclosure. As colorants, any dyes, pigments, and the like known to be used as colorants in toner may be used; here, seeing that a magnetic powder and a nigrosine dye tend to be black, the toner according to the present disclosure is preferably a black toner, and the colorant is preferably black. Examples of such colorants include carbon black, aniline black, and titanium-based black pigments.

### (Release Agent)

For the purpose of improving its fixing properties and offset resistance, the toner base particle can contain a release agent. The type of release agent that can be added to the toner base particle is not particularly limited. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such release agents to the toner base particle helps more efficiently suppress offsetting and image smearing (stain around an image caused by its being rubbed).

When a polyester resin is used as the binder resin, from the viewpoint of compatibility, as the release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as the release agent, Fischer-Tropsch wax and/or paraffin wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax C1 (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner base particle, preferably 1 mass % or more but 10 mass % or less. Using too small an amount of release agent can result in less-than-expected suppression of offsetting or image smearing in image formation; using too large an amount of release agent can result in fusing-together of toner particles and hence poor heat-resistant preservation properties of the toner.

### (Charge Control Agent)

In the toner according to the present disclosure, the nigrosine dye contained as a colorant in the toner base particles functions as a positively chargeable charge control agent, but the toner may contain any positively chargeable charge control agent other than a nigrosine dye within the scope consistent with the effect of the present disclosure.

Specific examples of positively chargeable charge control agents that can be contained in the toner base particle include: azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; metal salts of naphthenic acid or higher fatty acids; triphenylmethane-based dyes; alkoxylated amines; alkylamides; and quaternary ammonium salts such as benzylmethylhexyldecylammonium and decyltrimethylammonium chloride. Two or more of these positively chargeable charge control agents can be used in combination.

Also usable as a positively chargeable charge control agent are resins that have as a functional group a quaternary ammonium salt, a carboxylic acid salt, or a carboxyl group. More specific examples include: styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of charge amount within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The toner base particle can be a toner base particle having no shell layer (non-capsule toner base particle) or a toner base particle having a shell layer (capsule toner base particle). Forming a shell layer on the surface of a non-capsule toner base particle (toner core particle) yields a capsule toner base particle. The shell layer can be composed substantially solely of a thermosetting resin, substantially solely of a thermoplastic resin, or of both a thermoplastic and a thermosetting resin.

### (External Additive)

In the toner according to the present disclosure, the surface of the toner base particle is treated with an external additive. The toner according to the present disclosure contains, as the external additive, strontium titanate particles. In a case where a nigrosine dye is added as a colorant, the toner has too high positive chargeability. Thus, externally adding strontium titanate particles can prevent excessive charging of the toner.

Usable as strontium titanate is strontium titanate having a metallic element added to it to change its properties such as its crystal structure, resistance, and shape. Examples of metallic elements include lanthanides, silicon, aluminum, calcium, magnesium, barium, phosphorus, sulfur, vanadium, chromium, manganese, iron, cobalt, nickel, copper, gallium, yttrium, zinc, niobium, molybdenum, ruthenium, rhodium, palladium, silver, indium, tin, antimony, tantalum, tungsten, rhenium, osmium, iridium, platinum, bismuth, zirconium, and niobium.

The strontium titanate particles used in the toner according to the present disclosure are surface modified (hydrophobically treated). Hydrophobically treating the surface of strontium titanate particles increases their surface electrical resistance and thus helps suppress the leakage of electric charge from the charged toner.

Examples of hydrophobic treatment agents for strontium titanate particles include silicon-containing organic compounds such as silane coupling agents (specifically, alkoxysilane compounds, silazane compounds, silicone oils, and the like), titanate-based coupling agents such as isopropyl triisostearyl titanate, organic fluorine compounds, organic fatty acids, and the like.

The volume resistivity of the strontium titanate particles used in the toner according to the present disclosure is 10 E+7 [Ω·cm] or more but 10 E+10 [Ω·cm] or less. The number average primary particle size of the strontium titanate particles is preferably 30 nm or more but 100 nm or less.

The amount of strontium titanate contained is preferably 0.1 to 1 mass % for the total mass of the toner particle (the toner base particle and the external additive). The coverage proportion of the surface of the toner base particle by the strontium titanate particles (the proportion of the region, out of the surface region of the toner base particle, covered by the strontium titanate particles) is preferably 2% or more but 30% or less.

In addition to the strontium titanate particles described above, any other external additive may be added within the scope consistent with the object of the present disclosure. The type of external additive that can be added is not particularly limited and thus any external additive known to be used in toner can be appropriately selected. Specific examples of suitable external additives include metal oxides such as silica, alumina, titanium oxide, magnesium oxide, zinc oxide, and barium titanate, and resin particles or the like. These external additives are added from the viewpoint of enhancing the charging properties, fluidity, cleaning properties, and the like of toner particles and attach to the surface of the toner base particle. Two or more types of such external additives can be used in combination.

### [Production Method for Toner]

Next, a production method for the toner according to the present disclosure will be described. The production method for the toner includes a production method for the toner base particle and a method for external addition treatment to attach the external additive to the surface of the toner base particle. The production method for the toner base particle is not particularly limited so long as it can form the toner base particle with a predetermined structure. As necessary, a toner base particle coated with a shell layer can be used. As a suitable production method for the positively chargeable toner described above, a method for producing the toner base particle and a method for external addition treatment will be described one by one below.

### (Method for Producing the Toner Base Particle)

The method for producing the toner base particle is not particularly limited so long as it can satisfactorily disperse a magnetic powder, a colorant (nigrosine dye), and any optional components such as a release agent and a charge control agent in the binder resin. Examples of suitable methods for producing the toner base particle include a pulverization method and an agglomeration method.

In the pulverization method, the binder resin and any components such as a magnetic powder, a colorant, a release agent, and a charge control agent are mixed using a mixer or the like; then the binder resin and the components blended in the binder resin are melted and kneaded using a kneader such as a uniaxial or biaxial extruder; and the cooled kneaded product is pulverized and classified. While the average particle size of the toner base particle is not particularly limited within the scope consistent with the object of the present disclosure, generally it is preferably 5 μm or more but 10 μm or less.

In the agglomeration method, in an aqueous solvent containing fine particles of each of the binder resin, a magnetic powder, a colorant, a release agent, a charge control agent, and the like, these fine particles are agglomerated until they have a predetermined particle size. This forms an agglomerate particle containing the binder resin, the release agent, the charge control agent, and the colorant. Subsequently, the obtained agglomerate particle is heated so that the components in the agglomerate particle coalesce. This yields a toner base particle with a predetermined particle size.

### (Method for External Addition Treatment)

The method for treatment of the toner base particle with the external additive is not particularly limited; the toner base particle can be treated by any known method. Specifically, the toner base particle is treated with the external additive using a mixer such as a Turbuler Mixer, a Henschel mixer, a Nauta mixer, or a V-type mixer under treatment conditions adjusted such that the particles of the external additive do not sink in the toner base particle.

The toner according to the present disclosure described above, in cases where images are formed for a long period in various environments including a high-temperature high-humidity environment and a low-temperature low-humidity environment, helps stabilize the charge amount of the toner. Thus, the images can be formed with the desired density. It is also possible to effectively suppress fogging in the formed image after durability printing. Accordingly, the toner according to the present disclosure can be suitably used in a variety of image forming apparatuses. Now, the effects of the present disclosure will be described more specifically by way of examples. The present disclosure is not limited in any way by those examples.

### EXAMPLES

### Production Example 1

### (Production of Nigrosine Dye A)

In the presence of iron chloride, iron, and hydrochloric acid, nitrobenzene was added to aniline and aniline hydrochloride and the mixture was subjected to an oxidation reaction under the condition of 160 to 180° C. to obtain crude nigrosine. After the obtained crude nigrosine was neutralized, aniline and a solution of sodium hydroxide were added for basification; then, using a centrifuge of a screw decanter type, nigrosine and iron hydroxide precipitate were separated, and after the iron hydroxide precipitate was removed, the obtained liquid was washed with water. After washing, to remove the residual nitrobenzene and aniline, methanol was further added and the mixture was stirred and washed while being heated to 60° C. After the reaction liquid was filtered and the solid content was dried, using a jet mill (PJM-100NP, manufactured by Nippon Pneumatic Mfg. Co., Ltd.), the product was pulverized down to a volume average particle size of 10 μm to obtain nigrosine dye A.

### (Production of Nigrosine Dye B)

200 g of nigrosine dye A and 1000 g of methanol were weighed in a beaker and were fully stirred and mixed to disperse the nigrosine dye in the methanol solution. The resulting slurry with nigrosine dye A dispersed in it was wet-pulverized using a wet milling machine (DYNO-MILL MULTI-LAB, manufactured by Shinmaru Enterprises Corporation, with a capacity of 1.4 L), which was a medium stirring mill. The pulverizing conditions were as follows: circumferential velocity: 10 m/s, medium (material: zirconia) diameter: 1.25 mm, solution flow rate: 45 kg/h, cooling water flow rate: 5 L/min, and pressure: 0.1 Kg/cm². After 15 minutes of circulating operation and 15 minutes of wet pulverizing, a slurry of fine-pulverized nigrosine dye was obtained. The obtained slurry was filtrated, washed, and dried to obtain nigrosine dye B. Its particle size distribution was checked to find that its D50 (50 percent cumulative frequency diameter) was 1 μm.

### (Production of Nigrosine Dye C)

After synthesis under similar conditions as for nigrosine dye A, using a jet mill (PJM-100NP, manufactured by Nippon Pneumatic Mfg. Co., Ltd.), the product was pulverized down to a volume average particle size of 20 μm to obtain nigrosine dye C.

### (Production of Nigrosine Dye D)

200 g of nigrosine dye A and 1000 g of methanol were weighed in a beaker and were fully stirred and mixed to disperse the nigrosine dye in the methanol solution. The resulting slurry with nigrosine dye A dispersed in it was wet-pulverized using a wet milling machine (DYNO-MILL MULTI-LAB, manufactured by Shinmaru Enterprises Corporation, with a capacity of 1.4 L), which was a medium stirring mill. The pulverizing conditions were as follows: circumferential velocity: 50 m/s, medium (material: zirconia) diameter: 1.25 mm, solution flow rate: 45 kg/h, cooling water flow rate: 5 L/min, and pressure: 0.1 Kg/cm². After 15 minutes of circulating operation and 15 minutes of wet pulverizing, a slurry of fine-pulverized nigrosine dye was obtained. The obtained slurry was filtrated, washed, and dried to obtain nigrosine dye D. Its particle size distribution was checked to find that its D50 (50 percent cumulative frequency diameter) was 0.5 μm.

### (Production of Nigrosine Dye E)

After synthesis under similar conditions as for nigrosine dye A, using a jet mill (PJM-100NP, manufactured by Nippon Pneumatic Mfg. Co., Ltd.), the product was pulverized down to a volume average particle size of 50 μm to obtain nigrosine dye E.

### Production Example 2

### (Production of Strontium Titanate Particle T-1)

Metatitanic acid obtained by a sulfuric acid process was bleached by deferrization, and an aqueous solution of sodium hydroxide was added to obtain a pH value of 9.0. The result was then desulfurized, was neutralized with hydrochloric acid down to a pH value of 5.8, and was then filtrated and washed. Water was added to a washed cake to obtain a slurry equivalent to 2.00 mol/L as TiO₂, and hydrochloric acid was added to obtain a pH value of 3.0 for deflocculation. Of this meta titanic acid, an amount equivalent to 0.5 mol of TiO₂ was collected and put in a 3 L reaction vessel. While the contents were stirred and mixed, they were heated to 90° C., then 300 mL of a 5 mol/L aqueous solution of sodium hydroxide was added over 20 hours, and then the contents were kept being mixed at 100° C. for one hour to complete the reaction.

After the reaction, the slurry was cooled down to 50° C. and then, with hydrochloric acid added to obtain a pH value of 5.0, was kept being stirred for one hour. The obtained precipitate was washed, hydrochloric acid was added to the slurry containing the precipitate to obtain a pH value of 6.5, and 10 mass % of isobutyl trimethoxy silane relative to the solid content was added, and the result was kept being stirred for one hour. Next, the product was filtrated and washed, and then the obtained solid content was dried for eight hours in the atmosphere at 120° C. to obtain Strontium Titanate Particle T-1 (average particle size: 40 nm, volume resistivity: 10 E+08 Ω·cm).

### (Production of Strontium Titanate Particle T-2)

Strontium Titanate Particle T-2 (average particle size: 40 nm, volume resistivity: 10 E+08 Ω·cm) was obtained by a similar procedure to that for the Strontium Titanate Particle T-1, except that the amount of isobutyl trimethoxy silane added was changed to 5 mass %.

### (Production of Strontium Titanate Particle T-3)

Strontium Titanate Particle T-3 (average particle size: 40 nm, volume resistivity: 10 E+10 Ω·cm) was obtained by a similar procedure to that for the Strontium Titanate Particle T-1, except that the amount of isobutyl trimethoxy silane added was changed to 15 mass %.

### (Production of Strontium Titanate Particle T-4)

Metatitanic acid obtained by a sulfuric acid process was bleached by deferrization, and an aqueous solution of sodium hydroxide was added to obtain a pH value of 9.0. The result was then desulfurized, was neutralized with hydrochloric acid down to a pH value of 5.8, and was then filtrated and washed. Water was added to a washed cake to obtain a slurry equivalent to 2.00 mol/L as TiO₂, and hydrochloric acid was added to obtain a pH value of 3.0 for deflocculation. Of this meta titanic acid, an amount equivalent to 0.5 mol of TiO₂ was collected and put in a 3 L reaction vessel. While the contents were stirred and mixed, they were heated to 80° C., then 300 mL of a 5 mol/L aqueous solution of sodium hydroxide was added over 20 hours, and then the contents were kept being mixed at 80° C. for one hour to complete the reaction.

After the reaction, the slurry was cooled down to 50° C. and then, with hydrochloric acid added to obtain a pH value of 5.0, was kept being stirred for one hour. The obtained precipitate was washed, hydrochloric acid was added to the slurry containing the precipitate to obtain a pH value of 6.5, and 13 mass % of isobutyl trimethoxy silane relative to the solid content was added, and the result was kept being stirred for one hour. Next, the product was filtrated and washed, and then the obtained solid content was dried for eight hours in the atmosphere at 120° C. to obtain Strontium Titanate Particle T-4 (average particle size: 30 nm, volume resistivity: 10 E+08 Ω·cm).

### (Production of Strontium Titanate Particle T-5)

Metatitanic acid obtained by a sulfuric acid process was bleached by deferrization, and an aqueous solution of sodium hydroxide was added to obtain a pH value of 9.0. The result was then desulfurized, was neutralized with hydrochloric acid down to a pH value of 5.8, and was then filtrated and washed. Water was added to a washed cake to obtain a slurry equivalent to 2.00 mol/L as TiO₂, and hydrochloric acid was added to obtain a pH value of 3.0 for deflocculation. Of this meta titanic acid, an amount equivalent to 0.5 mol of TiO₂ was collected and put in a 3 L reaction vessel. While the contents were stirred and mixed, they were heated to 100° C., then 300 mL of a 5 mol/L aqueous solution of sodium hydroxide was added over ten hours, and then the contents were kept being mixed at 100° C. for one hour to complete the reaction.

After the reaction, the slurry was cooled down to 50° C. and then, with hydrochloric acid added to obtain a pH value of 5.0, was kept being stirred for one hour. The obtained precipitate was washed, hydrochloric acid was added to the slurry containing the precipitate to obtain a pH value of 6.5, and 5 mass % of isobutyl trimethoxy silane relative to the solid content was added, and the result was kept being stirred for one hour. Next, the product was filtrated and washed, and then the obtained solid content was dried for eight hours in the atmosphere at 120° C. to obtain Strontium Titanate Particle T-5 (average particle size: 100 nm, volume resistivity: 10 E+08 Ω·cm).

### (Production of Strontium Titanate Particle T-6)

Strontium Titanate Particle T-6 (average particle size: 40 nm, volume resistivity: 10 E+11 Ω·cm) was obtained by a similar procedure to that for the Strontium Titanate Particle T-1, except that the amount of isobutyl trimethoxy silane added was changed to 20 mass %.

### (Production of Strontium Titanate Particle T-7)

Strontium Titanate Particle T-7 (average particle size: 40 nm, volume resistivity: 10 E+06 Ω·cm) was obtained by a similar procedure to that for the Strontium Titanate Particle T-1, except that the amount of isobutyl trimethoxy silane added was changed to 2 mass %.

### Production Example 3

### (Production of Toner Base Particles)

The following were mixed using an FM mixer (FM-20B, manufactured by NIPPON COKE & ENGINEERING CO., LTD.) to obtain a mixture: as a binder resin, 100 mass parts of polyester resin (HP-313, manufactured by The Nippon Synthetic Chemical Industry Co., Ltd.); 50 mass parts of a magnetic powder (Magnetite MG1306, manufactured by MITSUI MINING & SMELTING CO., LTD.); as a colorant, 5 mass parts of nigrosine dye A obtained in Production Example 1; and as a release agent, 10 mass parts of paraffin wax (HNP-9, manufactured by NIPPON SEIRO CO., LTD.).

The obtained mixture was melted and kneaded at 150° C. using a biaxial extruder (TEM-45, manufactured by Toshiba Machine Co., Ltd.) to obtain a kneaded product. The kneaded product was cooled and was then coarsely pulverized using a pulverizer (Model Feather Mill 350×600, manufactured by HOSOKAWA MICRON CORPORATION). The obtained coarsely pulverized product was pulverized using an airflow type pulverizer (Model Jet Mill IDS-2, manufactured by Nippon Pneumatic Mfg. Co., Ltd.) to obtain a fine-pulverized product. The fine-pulverized product was then classified using a wind classifier (Model Elbow-Jet EJ-LABO, manufactured by Nittetsu Mining Co., Ltd.) to obtain toner base particles.

### Production Example 4

### (Production of Toner)

To 100 mass parts of the toner base particles obtained in Production Example 3, as external additives, 1.5 mass parts of silica particles (AEROSIL REA90, manufactured by NIPPON AEROSIL CO., LTD.) and 0.2 mass parts of Strontium Titanate Particle T-1 obtained in Production Example 2 were added and these were mixed using an FM mixer (FM-10, manufactured by NIPPON COKE & ENGINEERING CO., LTD.) to attach (externally add) the silica particles and Strontium Titanate Particle T-1 to the toner base particles. After that, the product was sieved through a 200 mesh sieve (with a mesh of 75 μm) using a vibration electric sieve (ANF-30, manufactured by NITTO KAGAKU CO., LTD.) to obtain toner of Present Disclosure 1.

The toners of Present Disclosure 2 to 13 and Comparative Examples 1 to 11 were obtained by a similar procedure to that for the toner of Present Disclosure 1, except that the types and amounts of nigrosine dye and other additives added in the toner base particles and of strontium titanate particles externally added to the toner base particles were changed. The types and amounts of nigrosine dye, strontium titanate particles, and other additives contained in the toners of Present Disclosure 1 to 13 and Comparative Examples 1 to 11 are shown in Table 1.

TABLE 1

| | Nigrosine Dye | | | Strontium Titanate Particles | | Other Additive | |
|---|---|---|---|---|---|---|---|
| | | | Amount | | Amount | | Amount |
| | | Particle Size | Added | | Added | | Added |
| Toner | Type | [μm] | [mass parts] | Type | [mass parts] | Substance | [mass parts] |
| Present Disclosure 1 | A | 10 | 5 | T-1 | 0.2 | None | — |
| Present Disclosure 2 | A | 10 | 2 | T-1 | 0.2 | None | — |
| Present Disclosure 3 | A | 10 | 20 | T-1 | 0.2 | None | — |
| Present Disclosure 4 | B | 1 | 5 | T-1 | 0.2 | None | — |
| Present Disclosure 5 | C | 20 | 5 | T-1 | 0.2 | None | — |
| Present Disclosure 6 | A | 10 | 4 | T-1 | 0.2 | Carbon Black | 1 |
| Present Disclosure 7 | A | 10 | 4 | T-1 | 0.2 | Quaternary Ammonium Salt | 1 |
| Present Disclosure 8 | A | 10 | 5 | T-2 | 0.2 | None | — |
| Present Disclosure 9 | A | 10 | 5 | T-3 | 0.2 | None | — |
| Present Disclosure 10 | A | 10 | 5 | T-1 | 0.1 | None | — |
| Present Disclosure 11 | A | 10 | 5 | T-1 | 1 | None | — |
| Present Disclosure 12 | A | 10 | 5 | T-4 | 0.2 | None | — |
| Present Disclosure 13 | A | 10 | 5 | T-5 | 0.2 | None | — |
| Comparative Example 1 | None | — | 5 | T-1 | 0.2 | Carbon Black | 5 |
| Comparative Example 2 | None | — | 5 | T-1 | 0.2 | Titanium Black | 5 |
| Comparative Example 3 | None | — | 5 | T-1 | 0.2 | Quaternary Ammonium Salt | 5 |
| Comparative Example 4 | None | — | — | T-1 | 0.2 | None | — |
| Comparative Example 5 | A | 10 | 5 | None | — | None | — |
| Comparative Example 6 | A | 10 | 1 | T-1 | 0.2 | None | — |
| Comparative Example 7 | A | 10 | 25 | T-1 | 0.2 | None | — |
| Comparative Example 8 | D | 0.5 | 5 | T-1 | 0.2 | None | — |
| Comparative Example 9 | E | 30 | 5 | T-1 | 0.2 | None | — |
| Comparative Example 10 | A | 10 | 5 | T-6 | 0.2 | None | — |
| Comparative Example 11 | A | 10 | 5 | T-7 | 0.2 | None | — |

### (Measurement of Amount of Nitrogen Element in Toner)

Using a CHN analysis device (2400II, manufactured by PerkinElmer), the amount of nitrogen element in toner was measured. The electric furnace temperature was 800° C. for the pyrolysis part and 900° C. for the catalyst part, and the measurement conditions were as follows: main O₂ flow rate: 300 mL/min, O₂ flow rate: 300 mL/min, and air flow rate: 400 mL/min. The quantification was performed based on a calibration curve prepared with a standard sample for calibration curve, such as indomethacin.

### (Measurement of Abs Value of Nigrosine Dye)

The Abs value of the nigrosine dye contained in the toner base particles was measured by the following method. First, a solution containing the methanol-soluble content of the toner base particle was prepared. 0.5 g of toner was measured in a vessel and 5.00 g of methanol was added to it. The contents of the vessel were mixed for three minutes at a rotation rate of 100 rpm using a ball mill at 25° C. The vessel was then left to stand for three minutes, and the supernatant was taken out from the contents of the vessel. Using a centrifuge, the solid components in the supernatant were precipitated, and the methanol solution was taken out from the supernatant. Thus, a methanol solution containing the methanol-soluble content of the toner was obtained.

The light absorbance (Abs value) of the obtained methanol solution containing the methanol-soluble content was measured using a spectrophotometer (U-3900, manufactured by Hitachi, Ltd.). Nigrosine characteristically absorbs ultraviolet light of a wavelength of 516 nm, so the light absorbance was measured by irradiating the methanol solution with ultraviolet light of wavelengths 300 nm or more but 800 nm or less.

### (Measurement of Volume Resistivity of Strontium Titanate Particle)

The volume resistivity of the strontium titanate particles was measured by the following method. The strontium titanate particles were subjected to 100 kg/cm² of pressure to be compression-molded into the shape of a tablet with a diameter of 10 mm, and then its electric resistance value was measured using a digital multimeter (DM7560, manufactured by Yokogawa Electric Corporation) and was converted to a specific resistance value to be taken as the volume resistivity of the strontium titanate.

### (Measurement of Number Average Primary Particle Size of Strontium Titanate Particle)

The number average primary particle size of the strontium titanate particles was measured by the following method. Strontium titanate was externally added to (dispersed in) the toner base particles, then 100 primary particles of strontium titanate were observed using a scanning electron microscope (JSM-7401F, manufactured by JEOL Ltd.) at a magnification of 40,000 times to measure the longest and shortest sizes of each particle by image analysis of the primary particles, and the intermediate value was measured as the equivalent circular size. The average size of 100 primary particles measured was taken the number average primary particle size.

### (Measurement of Coverage Proportion of Surface of Toner by Strontium Titanate Particle)

The coverage proportion of the surface of the toner base particle by strontium titanate particles was measured by the following method. First, using a scanning electron microscope (SEM), a 30,000-times photograph of the surface of toner particle was taken. Then, in the same field of view, EDX elemental analysis was performed to obtain an Sr element distribution image. The obtained SEM image and Sr element distribution image were analyzed using an image processing analyzer (WINROOF, manufactured by Mitani Corporation). The area of strontium titanate was calculated from a brightness distribution image and the Sr element distribution image, and the coverage proportion of the surface of the toner base particle was calculated as the area proportion of the image area of strontium titanate in the image area of the toner base particle.

For the toners of Present Disclosure 1 to 13 and Comparative Examples 1 to 11, the nitrogen content, the Abs value of nigrosine dye, the volume resistivity of strontium titanate particles externally added to the toner base particle, the number average primary particle size, and the coverage proportion of the surface of the toner by the strontium titanate are shown in Table 2.

TABLE 2

| | Amount of | | Strontium Titanate Particles | | |
|---|---|---|---|---|---|
| | Nitrogen | | Volume | Particle | Coverage |
| | Element | Abs | Resistivity | Size | Proportion |
| Toner | [mass %] | Value | [Ω · cm] | [μm] | [%] |
| Present | 1 | 0.5 | 1.0E+8 | 40 | 6 |
| Disclosure 1 | | | | | |
| Present | 0.5 | 0.5 | 1.0E+8 | 40 | 6 |
| Disclosure 2 | | | | | |
| Present | 5 | 0.5 | 1.0E+8 | 40 | 6 |
| Disclosure 3 | | | | | |
| Present | 1 | 0.2 | 1.0E+8 | 40 | 6 |
| Disclosure 4 | | | | | |
| Present | 1 | 2 | 1.0E+8 | 40 | 6 |
| Disclosure 5 | | | | | |
| Present | 0.8 | 0.5 | 1.0E+8 | 40 | 6 |
| Disclosure 6 | | | | | |
| Present | 0.8 | 0.6 | 1.0E+8 | 40 | 6 |
| Disclosure 7 | | | | | |
| Present | 1 | 0.5 | 1.0E+7 | 40 | 6 |
| Disclosure 8 | | | | | |
| Present | 1 | 0.5 | 1.0E+10 | 40 | 6 |
| Disclosure 9 | | | | | |
| Present | 1 | 0.5 | 1.0E+8 | 40 | 2 |
| Disclosure 10 | | | | | |
| Present | 1 | 0.5 | 1.0E+8 | 40 | 30 |
| Disclosure 11 | | | | | |
| Present | 1 | 0.5 | 1.0E+8 | 30 | 8 |
| Disclosure 12 | | | | | |
| Present | 1 | 0.5 | 1.0E+8 | 100 | 3 |
| Disclosure 13 | | | | | |
| Comparative | — | — | 1.0E+8 | 40 | 6 |
| Example 1 | | | | | |
| Comparative | — | — | 1.0E+8 | 40 | 6 |
| Example 2 | | | | | |
| Comparative | 0.1 | — | 1.0E+8 | 40 | 6 |
| Example 3 | | | | | |
| Comparative | — | — | 1.0E+8 | 40 | 6 |
| Example 4 | | | | | |
| Comparative | 1 | 0.5 | — | — | — |
| Example 5 | | | | | |
| Comparative | 0.3 | 0.5 | 1.0E+8 | 40 | 6 |
| Example 6 | | | | | |
| Comparative | 6.5 | 2.5 | 1.0E+8 | 40 | 6 |
| Example 7 | | | | | |
| Comparative | 0.5 | 0.1 | 1.0E+8 | 40 | 6 |
| Example 8 | | | | | |
| Comparative | 0.5 | 2.1 | 1.0E+8 | 40 | 6 |
| Example 9 | | | | | |
| Comparative | 1 | 0.5 | 1.0E+11 | 40 | 6 |
| Example 10 | | | | | |
| Comparative | 1 | 0.5 | 1.0E+6 | 40 | 6 |
| Example 11 | | | | | |

### [Evaluation of Image Density, Coloring Ability, Condition of Toner Thin Layer]

With each of the toners of Present Disclosure 1 to 13 and Comparative Examples 1 to 11, the image density, the coloring ability, and the condition of the toner thin layer as observed when it was used were evaluated by the methods described below.

### (Image Density)

As an evaluation machine, a monochrome printer (ECOSYS FS-3060DN, manufactured by KYOCERA Document Solutions Inc.) was used. Each of the toners of Present Disclosure 1 to 13 and Comparative Examples 1 to 11 obtained in Production Example 4 was installed in a development portion in the evaluation machine. On the other hand, replenishment toner (the same toner as that installed in the development portion) was installed in a toner container in the evaluation machine. After the toner was installed, in a normal-temperature normal-humidity environment (temperature: 23° C., humidity: 50% RH), a text document with a coverage ratio of 1% was printed on 1,000 printing sheets (Multipaper Super Economy A4, manufactured by ASKUL Co., Ltd.) in duplex printing mode. After that, an evaluation image (evaluation image 1) including a solid image was printed on one printing sheet.

After evaluation image 1 was printed, the evaluation machine was moved to a high-temperature high-humidity environment (temperature: 28° C., humidity: 80% RH) and was exposed to that same environment for 24 hours; then, a text document with a coverage ratio of 1% was printed on 4,000 printing sheets in a duplex printing mode. After that, an evaluation image (evaluation image 2) including a solid image was printed on one printing sheet.

Using a reflection densitometer (TC-60, manufactured by Tokyo Denshoku Co., Ltd.), the image density of evaluation image 1 (evaluation value 1) and the image density of evaluation image 2 (evaluation value 2) were measured. The evaluation criteria for image density (ID) were as follows:
GOOD: the ID of evaluation value 1 was 1.2 or more and in addition the ID of evaluation value 2 was 1.0 or more.
POOR: the ID of evaluation value 1 was less than 1.2 or the ID of evaluation value 2 was less than 1.0.

### (Coloring Ability)

Using a fluorospectro-densitometer (FD-5, manufactured by Konica Minolta, Inc.), the brightness L* and the chromaticity a* and b* of evaluation image 1 obtained for the evaluation of image density were measured. The evaluation criteria for coloring ability were as follows:
GOOD: L*≤20 and a*≤0 and b*≤0.5
POOR: L*>20 or a*>0 or b*>0.5

### (Condition of Toner Thin Layer)

Using the evaluation machine, in a low-temperature low-humidity environment (temperature: 10° C., humidity: 10% RH), a text document with a coverage ratio of 1% was printed on 1,000 printing sheets in duplex printing mode. The printed document was visually inspected to check for fogging (toner scattered on an unprinted part) and image defects due to the scattering of toner. The development device was removed from the evaluation machine after image evaluation and the toner thin layer formed on the toner carrying member (developing sleeve) was visually inspected to check for faults in the formed toner thin layer, such as toner clogging, streaks, or deposits. The evaluation criteria for condition of the toner thin layer were as follows:
GOOD: no image defect was observed and no fault was observed in the toner thin layer on the toner carrying member.
POOR: an image defect was observed or a fault was observed in the formed toner thin layer on the toner carrying member.

Table 3 shows the results of evaluation of the image density, the coloring ability, and the condition of the toner thin layer as observed with each of the toners of Present Disclosure 1 to 13 and Comparative Examples 1 to 11.

TABLE 3

| | Image Density | | | Coloring Power | | | | |
|---|---|---|---|---|---|---|---|---|
| | Evaluation | Evaluation | | Brightness and Chromaticity | | | | Condition of |
| Toner | Value 1 | Value 2 | Evaluation | L* | a* | b* | Evaluation | Thin Layer |
| Present Disclosure 1 | 1.3 | 1.2 | GOOD | 18 | −0.7 | −0.6 | GOOD | GOOD |
| Present Disclosure 2 | 1.3 | 1.2 | GOOD | 18 | −0.5 | −0.5 | GOOD | GOOD |
| Present Disclosure 3 | 1.3 | 1.2 | GOOD | 19 | −0.9 | −1 | GOOD | GOOD |
| Present Disclosure 4 | 1.3 | 1.2 | GOOD | 19 | −0.3 | 0.6 | GOOD | GOOD |
| Present Disclosure 5 | 1.3 | 1 | GOOD | 17 | −0.9 | −1.1 | GOOD | GOOD |
| Present Disclosure 6 | 1.3 | 1.2 | GOOD | 16 | −0.6 | −0.6 | GOOD | GOOD |
| Present Disclosure 7 | 1.3 | 1.1 | GOOD | 17 | −0.5 | −0.6 | GOOD | GOOD |
| Present Disclosure 8 | 1.3 | 1.2 | GOOD | 18 | −0.7 | −0.6 | GOOD | GOOD |
| Present Disclosure 9 | 1.3 | 1.2 | GOOD | 18 | −0.7 | −0.6 | GOOD | GOOD |
| Present Disclosure 10 | 1.3 | 1.1 | GOOD | 18 | −0.7 | −0.7 | GOOD | GOOD |
| Present Disclosure 11 | 1.3 | 1 | GOOD | 16 | −0.1 | −0.5 | GOOD | GOOD |
| Present Disclosure 12 | 1.3 | 1.1 | GOOD | 18 | −0.7 | −0.7 | GOOD | GOOD |
| Present Disclosure 13 | 1.3 | 1.1 | GOOD | 17 | −0.5 | 0.5 | GOOD | GOOD |
| Comparative Example 1 | 1.2 | 0.6 | POOR | 16 | −0.8 | 0 | POOR | GOOD |
| Comparative Example 2 | 1.2 | 1.1 | POOR | 17 | 1.2 | 1 | POOR | POOR |
| Comparative Example 3 | 1.3 | 1 | GOOD | 18 | 1.9 | 2.8 | POOR | GOOD |
| Comparative Example 4 | 1.2 | 1.1 | POOR | 19 | 20 | 2.8 | POOR | POOR |
| Comparative Example 5 | 1.3 | 1 | GOOD | 19 | −0.8 | −0.8 | GOOD | POOR |
| Comparative Example 6 | 1.3 | 1.2 | GOOD | 20 | 0.2 | −0.2 | POOR | GOOD |
| Comparative Example 7 | 1.2 | 0.9 | POOR | 16 | −1 | −1.2 | GOOD | GOOD |
| Comparative Example 8 | 1.3 | 1 | POOR | 20 | −0.1 | −0.5 | GOOD | POOR |
| Comparative Example 9 | 1.2 | 0.9 | POOR | 16 | −0.9 | −1.1 | GOOD | GOOD |
| Comparative Example 10 | 1.3 | 1.2 | GOOD | 18 | −0.7 | −0.6 | GOOD | POOR |
| Comparative Example 11 | 1.3 | 0.9 | POOR | 18 | −0.7 | −0.6 | GOOD | GOOD |

Tables 2 and 3 reveal the following. The toners of Present Disclosure 1 to 13, in which the amount of nitrogen element in toner particles was 0.5 mass % or more but 5 mass % or less, the light absorbance (Abs value) of toner particles with respect to methanol as measured with an absorptiometer was 0.2 or more but 2.0 or less, and the volume resistivity of strontium titanate particles externally added to the toner base particle was 1.0 E+7 [Ω·cm] or more but 1.0 E+10 [Ω·cm] or less, all yielded satisfactory evaluation results for image density, coloring ability, and toner thin layer condition.

In contrast, the toners of Comparative Examples 1 to 3, in which instead of a nigrosine dye, carbon black, titanium black, and quaternary ammonium salt were added, and the toner of Comparative Example 4, in which no colorants were added, all yielded a poor evaluation result for coloring ability. The toners of Comparative Examples 1, 2, and 4 exhibited a low image density and the toners of Comparative Examples 2 and 4 exhibited faults in the toner thin layer. The toner of Comparative Example 5, in which no strontium titanate particles were added, ended in being excessively charged and exhibited faults in the toner thin layer.

The toner of Comparative Example 6, in which the amount of nitrogen element in toner particles was 0.3 mass %, contained an insufficient amount of nigrosine dye and yielded a poor evaluation result for coloring ability. On the other hand, the toner of Comparative Example 7, in which the amount of nitrogen element in toner particles was 6.5 mass % and the Abs value was 2.5, contained an excessive amount of nigrosine dye and exhibited a low image density due to insufficient charging of toner.

The toner of Comparative Example 8, in which the Abs value was 0.1, contained a nigrosine dye with a particle size of 0.5 μm, so small that the nigrosine dye was not dispersed on the surface of the toner base particle (low Abs value), exhibited a low image density due to insufficient charging of toner. On the other hand, the toner of Comparative Example 9, which contained a nigrosine dye with a particle size as large as 30 μm, ended in the nigrosine dye coming off from the surface of the toner base particles and exhibited a low image density due to insufficient charging of toner.

The toner of Comparative Example 10, in which the volume resistivity of strontium titanate particles was 1.0 E+11 [Ω·cm], had too high a volume resistivity of strontium titanate particles, resulting in the toner being excessively charged and exhibiting faults in the toner thin layer. On the other hand, the toner of Comparative Example 11, in which the volume resistivity of strontium titanate particles was 1.0 E+6 [Ω·cm], had too low a volume resistivity of strontium titanate particles, resulting in the toner being insufficiently charged and exhibiting a low image density.

The results above indicate that, by adding a nigrosine dye to the toner base particle, externally adding strontium titanate particles to the surface of the toner base particle, setting the amount of nitrogen element in toner particles to 0.5 mass % or more but 5 mass % or less, setting the light absorbance (Abs value) of toner particles with respect to methanol as measured with an absorptiometer to 0.2 or more but 2.0 or less, and setting the volume resistivity of strontium titanate particles externally added to the toner base particle to 1.0 E+7 [Ω·cm] or more but 1.0 E+10 [Ω·cm] or less, it is possible to obtain magnetic one-component toner that has enhanced image density and coloring ability and that can prevent faults in the condition of the toner thin layer.

The present disclosure finds application in positively chargeable magnetic one-component toner for use in an electrophotographic method. Based on the present disclosure, it is possible to enhance the blackness of toner and to provide magnetic one-component toner that can keep its charging properties stable over a long period.

What is claimed is:

1. Magnetic one-component toner composed of toner particles, the toner particles comprising:
a toner base particle that contains at least a binder resin and a magnetic powder; and
an external additive attached to a surface of the toner base particle, wherein
the toner base particle contains a nigrosine dye,
the external additive contains strontium titanate particles of which a surface is hydrophobically treated,
an amount of nitrogen element in the toner particles is 0.5 mass % or more but 5 mass % or less,
an Abs value representing an amount of nigrosine dye that dissolves when the toner particles are immersed in methanol as expressed in terms of light absorbance is 0.2 or more but 2.0 or less,
a volume resistivity of the strontium titanate particles is 1.0 E+7 [Ω·cm] or more but 1.0 E+10 [Ω·cm] or less.

2. The magnetic one-component toner according to claim 1, wherein
a number average primary particle size of the strontium titanate particles is 30 nm or more but 100 nm or less.

3. The magnetic one-component toner according to claim 1, wherein
a coverage proportion of the surface of the toner base particle by the strontium titanate particles is 2% or more but 30% or less.

4. The magnetic one-component toner according to claim 1, wherein
the toner base particle is formed by a pulverization method in which at least the binder resin, the magnetic powder, and the nigrosine dye are melted and kneaded by a melting and kneading process and then a cooled kneaded product is pulverized.

5. An image forming apparatus, comprising:
a development device that develops an electrostatic latent image formed on an image carrying member using the magnetic one-component toner of claim 1 to form a toner image;
a transfer device that transfers the toner image developed by the development device to a recording medium; and
a cleaning device that removes the toner remaining on the image carrying member, wherein
the development device employs a magnetic one-component jumping development system that electrostatically charges the magnetic one-component toner via a toner carrying member that carries the magnetic one-component toner, and
the cleaning device employs a blade cleaning system that removes the toner remaining on the image carrying member with a cleaning blade.
